(19) United States
(12) Patent Application Publication
(10) Pub. No.: US 2024/0193126 A1
(43) Pub. Date: Jun. 13, 2024

(54) FILE RECOMMENDATION BASED ON RECORDED EVENT DATA AND FILE DATA ASSOCIATIONS

(71) Applicant: Hewlett-Packard Development Company, L.P., Spring, TX (US)

(72) Inventors: Andre Da Fonte Lopes Da Silva, Palo Alto, CA (US); Richard Edward Hodges, Spring, TX (US); Carol Tatsuko Ozaki, Palo Alto, CA (US); Eunkyeol Kim, Palo Alto, CA (US)

(73) Assignee: Hewlett-Packard Development Company, L.P., Spring, TX (US)

(21) Appl. No.: 18/555,680

(22) PCT Filed: Apr. 23, 2021
(86) PCT No.: PCT/US2021/028932

§ 371 Date: Oct. 16, 2023

(51) Int. Cl. G06F 16/14; G06F 16/11; G06F 16/176

(52) U.S. Cl. CPC G06F 16/156; G06F 16/116; G06F 16/176

(57) ABSTRACT

An example method includes: storing, for an account identifier representing a user account, event data for events associated with the account identifier and file data for files owned by the account identifier; tracking associations between the event data and the file data, each association representing a recorded access of a file during an event; obtaining a set of parameters for a file retrieval request; comparing the set of parameters and the associations between the event data and the file data; and selecting a recommended file for the file retrieval request based on the comparison of the set of parameters and the associations between the event data and the file data.

### BACKGROUND

Modern day office workers often access, edit, and view many files over the course of their working days. These files can be stored in different repositories, including online cloud-based services, and local work machines, which may span multiple devices.

### BRIEF DESCRIPTION OF THE DRAWINGS

FIG. 1 is a flowchart of an example method of selecting a recommended file based on recorded event data and file data associations.

FIG. 2 is a block diagram of an example system for selecting a recommended file based on recorded event data and file data associations.

FIG. 3 is a block diagram of an example non-transitory machine-readable storage medium storing instructions for selecting a recommended file based on recorded event data and file data associations.

FIG. 4 is a block diagram of a shared device from the system of FIG. 2 capable of selecting a recommended file based on recorded event data and file data associations.

FIG. 5 is a flowchart of an example method of selecting a recommended file based on recorded event data and file data associations in the shared device of FIG. 4.

FIG. 6 is a flowchart of an example method of associating the event assistant interface to a user account at block 504 of FIG. 5.

FIGS. 7A-7D are schematic diagrams of the event assistant interface during execution of the methods of FIGS. 5 and 6.

### DETAILED DESCRIPTION

The multitude of files and storage options can make files difficult to find, in particular, when users are under a time crunch, for example during meetings or other events. This problem may be compounded when users have back to back meetings and do not have time to prepare. Some systems may provide file recommendations based on recency of the last access, and how the files were received, but do not consider the specific context or parameters of a given file request, such as details pertaining to ongoing events.

An example file recommendation system uses historical event data and file data and recorded associations therebetween to make file recommendations. An event assistant application retrieves and tracks event data, such as calendar events, meetings, and meeting participants, and file data for files owned by a user account. The event assistant application further retrieves or tracks associations between the event data and the file data representing the access (i.e., viewing, editing, or similar) of a file during an ongoing event. Based on the association between the recorded contextual event data of a file access, the application may compare a set of parameters of a file retrieval request to the associations to select a recommended file. In particular, the recommended file may be one which has associations to event data which closely matches the parameters of the file retrieval request.

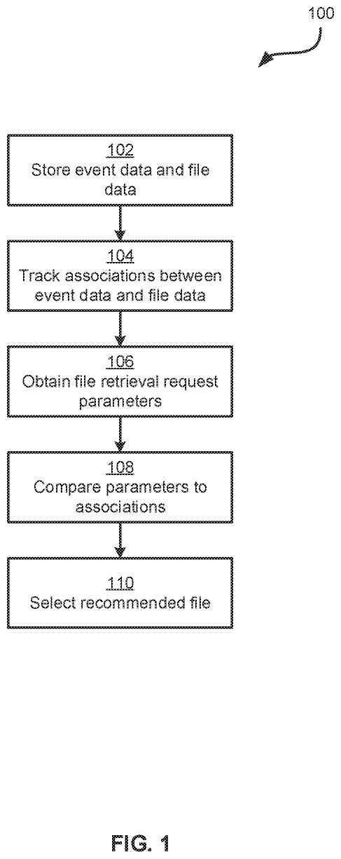

FIG. 1 depicts a flowchart of an example method 100 of recommending a file based on recorded event data and file data associations. The method 100 may be performed at least in part by a processor of a computing device executing stored instructions for an event assistant application. For example, the method 100 may be performed by a personal computing device or a server supporting an event assistant application. In other examples, the method 100 may be performed by other suitable devices or systems.

The method 100 begins at block 102, where file data and event data are stored. For example, event data may be stored at an event repository. The event data may include data representing calendar events (e.g., meetings, appointments, and the like), such as event start and end times and/or dates, event titles, event bodies (i.e., lengthier descriptors of the calendar event), event participants, and other relevant event metadata. In particular, the event data may be associated with account identifiers representing user accounts associated with the events. In some examples, in addition to storing event data, the event repository may further store account data for the account identifiers, including personal data for the users of the user accounts, as well as different types of account identifiers (e.g., email address, login ID, phone number, etc.) associated with the user account. In other examples, account data may be stored at a separate repository. The file data may be stored at a file repository and may include metadata such as a file author or creator, last revision date, time accessed, and the like. The file data may also be associated with an account identifier representing the user account which owns the file.

At block 104, associations between the event data and the file data are tracked. In particular, each association represents a recorded access of a file during an event. For example, the associations may be recorded by a computing device being operated by a user of a user account. When the computing device detects that an event is underway based on the event data, the computing device may track the files which the user accesses during the event. This may include for example, identifying files which are in focus during the event, files which are opened and/or edited during the event, and the like as accompanying files. The computing device may then store associations between the accompanying files and the event. More particularly, the computing device may store associations between the event data representing the event (e.g., the event parameters of the event) and the file data representing the accompanying file (e.g., the file identifier or other metadata for the file), as well as the account identifier for the user account. The computing device may store the associations locally and/or send them to a central server to consolidate event data and file data associations for each user account.

At block 106, a file retrieval request is received at a computing device or a server implementing the event assistant application. The file retrieval request specifies a set of parameters relating to the file to be retrieved as well as an account identifier representing the user account generating the file retrieval request. In some examples, the file retrieval request may be initiated based on a subsequent event being initiated. That is, when an event begins (i.e., subsequent to the recording of an association between file data and event data based on the access of a file during an event), the computing device may generate a file retrieval request using the event parameters as the parameters of the file retrieval request.

In other examples, the file retrieval request may be initiated by a user operating the computing device. For example, the user may wish to retrieve a file accessed during a recently occurring meeting with a number of participants. Accordingly, the user may input, for example, identifiers for the participants as parameters for the file retrieval request. In still further examples, the file retrieval request may be received from another computing device (e.g., at the server) based on an event being initiated or based on user input at the other computing device.

At block 108, the computing device compares the set of parameters of the file retrieval request to the associations tracked and stored at block 104 for the account identifier associated with the user account which generated the file retrieval request. For example, the computing device may look for similarities in the groups of participants of a given meeting and a group of account identifiers specified in the file retrieval request. Alternately or additionally, the computing device may identify similarities in the titles or bodies of a previous event and the event parameters specified in the file retrieval request. In some examples, the computing device may employ machine learning algorithms to compare the set of parameters and the associations.

At block 110 the computing device selects a recommended file based on the comparison at block 108. For example, if the computing device identifies similarities between the group of participants of a given meeting and a group of account identifiers specified in the file retrieval request, the computing device may select the file associated with the group of participants (i.e., based on the association of the group of participants and an accessed file during an event involving the group of participants) as the recommended file. In some examples, more than one recommended file may be selected, and the recommended files may be ranked based on the similarities to the set of parameters from the file retrieval request. The computing device may then output the recommended file or files, for example at a display of the computing device, or by returning the recommended file to the other computing device from which the file retrieval request was initiated.

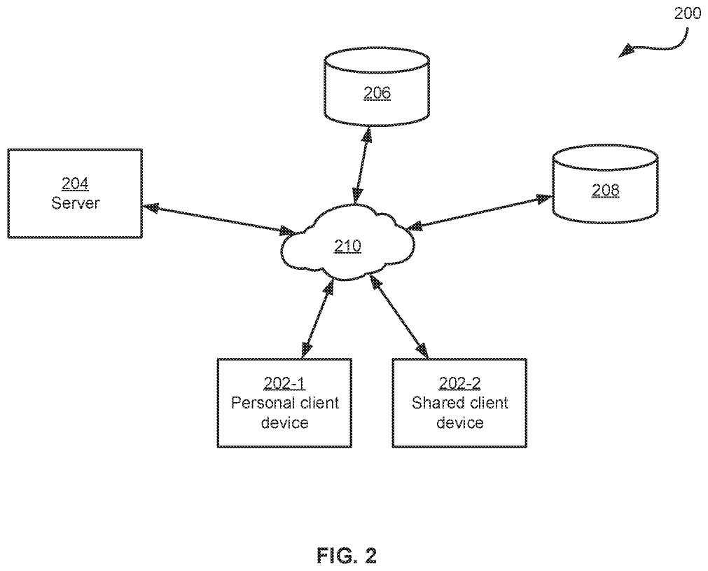

FIG. 2 depicts a block diagram of an example system 200 for recommending files based on recorded event data and file data associations. The system 200 includes client devices 202, of which two example client devices 202-1 and 202-2 are depicted, a server 204, an event repository 206, and a file repository 208, in communication via a network 210.

The client devices 202-1, 202-2 (referred to herein generically as a client device 202, and collectively as the client devices 202) may be computing devices, such as laptops computers, desktop computers, tablets, mobile phones or the like. The client devices 202 may generally be used by users to attend meetings or other events, as well as to view and edit files, make notes, and the like. In the present example, the client device 202-1 is a personal computing device associated with a particular user, based on a user account identifier, or the like, and hence may be referred to herein as the personal device 202-1. The client device 202-2 is a shared computing device which may be used by multiple users. For example, any user in an organization may sign on to a shared laptop computer or desktop computer, or a group of users may collectively use a tablet or smart board implementing a collaboration application, such as a whiteboard application in which multiple users may each use an input device to independently and simultaneously in. In other examples, the collaboration application may include meeting applications, including screen share or attachment functionalities of a conference call or chat, or the like.

The client devices 202 may implement an event assistant application which performs file recommendations. Accordingly, the client devices 202 include processors and memories storing machine-readable instructions which, when executed, cause the client devices 202 to perform the functionality described herein. The client devices 202 may also include suitable communications interfaces (e.g., including transmitters, receivers, network interface devices, and the like) to communicate with other computing devices, such as the server 204, the event repository 206, and the file repository 208 via the network 210.

The server 204 may be any suitable server environment, including a cloud-based server, a series of cooperating servers, and the like. The server 204 is generally to support file recommendation operations and may store associations between event data and file data, and in particular, associations for each user account subscribing to or implementing an event assistant application which performs file recommendations. In some examples, the server 204 may additionally store a copy of the event data and the file data locally at the server 204 in a database. In some examples, the server 204 may be to select a recommended file based on a file retrieval request. The server 204 may therefore include a processor and a memory storing machine-readable instructions which, when executed, cause the server 204 to perform the functionality described herein. The server 204 may also include a suitable communications interface (e.g., including transmitters, receivers, network interface devices, and the like) to communicate with other computing devices, such as the client devices 202, the event repository 206, and the file repository 208 via the network 210.

The event repository 206 is a repository, such as a data lake, accessible by multiple client devices, such as the client devices 202, the server 204 and other computing devices, for storing event data representing events. The event data may include data representing calendar events (e.g., meetings, appointments, and the like), such as event start and end times and/or dates, event titles, event bodies (i.e., lengthier descriptors of the calendar event), event participants, and other relevant event metadata. In particular, the event data may be associated with account identifiers representing user accounts associated with the events. In some examples, in addition to storing event data, the event repository may further store account data for the account identifiers, including personal data for the users of the user accounts, as well as different types of account identifiers (e.g., email address, login ID, phone number, etc.) associated with the user account. In other examples, account data may be stored at a separate repository.

The event repository 206 may be operated, for example, by an email service provider. Accordingly, the event repository 206 is illustrated in the present example as a separate entity; in other examples, the event repository 206 may be integrated with the server 204 and/or the file repository 208.

The file repository 208 is a repository, such as a data lake, accessible by multiple client devices, such as the client devices 202, the server 204 and other computing devices, for storing file data representing files. The file data may include metadata such as a file author or creator, last revision date, time accessed, and the like. The file data may also be associated with an account identifier representing the user account which owns the file. For example, the file repository 208 may be operated by a file hosting service provider. Accordingly, the file repository 208 is illustrated in the present example as a separate entity; in other examples, the file repository 208 may be integrated with the server 204 and/or the event repository 206. In further examples, the file repository 208 may be integrated with one of the computing devices 202. That is, the file repository 208 may represent the files stored locally on the computing device 202.

Further, in some examples, the system 200 may include more than one event repository 206 and file repository. For example, if a user uses calendar applications hosted by more than one service provider, the system 200 may connect to the event repositories hosted by each service provider to obtain event data associated with each service provider for the user account. Similarly if a user owns files stored locally and at a file hosting service provider, the system 200 may reference both the local file repository as well as the file repository hosted by each file hosting service provider to obtain file data for the user account.

The client devices 202, the server 204, the event repository 206, and the file repository 208 are in communication with one another via the network 210. The network 210 may include wired or wireless networks, including wide-area networks, such as the Internet, mobile networks, local area networks employing routers, switches, wireless access points, combinations of the above, and the like.

In operation, the event repository 206 and the file repository 208 store event data for events associated with account identifiers, and file data for files owned by account identifiers. Users may operate the client devices 202 during meetings or other events to attend the meeting, as well as to view, edit and share documents or files with meeting participants. Accordingly, the client devices 202 may implement an event assistant application to facilitate meeting attendance as well as retrieval of relevant documents for the meeting.

In some examples, the event assistant application may be executed on the personal device 202-1, and hence the event assistant application may identify an account identifier for the personal device 202-1 for which to track ongoing and upcoming events and select recommended files, for example via execution of the method 100. Accordingly, the personal device 202-1 includes a memory storing an event assistant application to perform the functionality described herein.

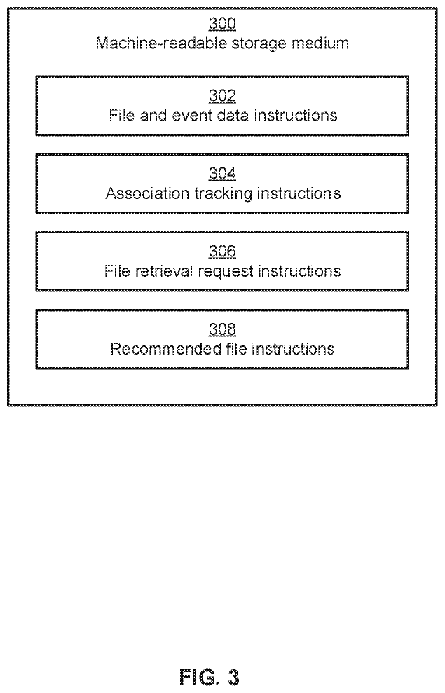

For example, referring to FIG. 3, an example non-transitory machine-readable storage medium 300 storing machine readable instructions is depicted. The storage medium 300 may be an electronic, magnetic, optical, or other physical storage device that stores executable instructions. In particular, the storage medium 300 stores file and event data instructions 302, association tracking instructions 304, file retrieval request instructions 306, and recommended file instructions 308. The instructions, when executed by a processor of the personal device 202-1, configure the personal device 202-1 to select a recommended file in response to a file retrieval request.

The file and event data instructions 302, when executed, cause the personal device 202-1 to obtain event data and file data. In order to select a recommended file, the personal device 202-1 may obtain copies of the event data and the file data. For example, the personal device 202-1 may obtain the event data and the file data from the event repository 206 and the file repository 208, respectively.

Specifically, the personal device 202-1 is associated with a particular account identifier representing a user account of a particular user. Accordingly, the personal device 202-1 may obtain event data for events associated with the account identifier and file data for files owned by the account identifier. For example, if the event repository 206 is hosted by a third-party service provider, the personal device 202-1 may request input from the user to enter credentials for the third-party service provider in order to access the event data. In other examples, the personal device 202-1 may retrieve previously stored credentials from memory to access the event data. Similarly, the personal device 202-1 may request and/or store credentials for another third-party service provider hosting the file repository 208. In other examples, the file repository 208 may correspond to the local file repository of the personal device 202-1.

The association tracking instructions 304, when executed, cause the personal device 202-1 to track associations between the file data and the event data. For example, when the personal device 202-1 detects that an event is underway based on the event data, the personal device 202-1 records all files accessed during the event. An accessed file may include a file which is opened and/or edited during the event, or a file in a program which is in focus during the event. The personal device 202-1 stores associations between the event data representing the event (e.g., the event parameters of the event) and the file data representing the file (e.g., the file identifier). The personal device 202-1 may store the associations locally in the memory of the personal device 202-1.

In some examples, in addition to storing the associations locally, the personal device 202-1 may send the associations, together with the account identifier of the user account associated with the personal device 202-1 to the server 204 to be stored. Thus, in some examples, to retrieve recorded associations detected, for example on a different computing device on which the user account is active, the personal device 202-1 may further retrieve a record of recorded associations from the server 204.

The file retrieval request instructions 306, when executed, cause the personal device 202-1 to identify a set of parameters defining the file retrieval request and compare them to the associations between the event data and the file data. For example, the set of parameters may include event parameters, participant identifiers, or the like.

For example, the personal device 202-1 may generate a file retrieval request based on the event data. More particularly, when an event begins, the personal device 202-1 may generate a file retrieval request with the event parameters as the parameters of the file retrieval request. That is, the file retrieval request may include parameters such as the event title, the event body, the event participants, and the like.

In other examples, the personal device 202-1 may generate the file retrieval request based in user input to the personal input device 202-1. For example, the user may wish to retrieve a file accessed during a recently occurring meeting with a number of participants. Accordingly, the user may input, for example, identifiers for the participants as parameters for the file retrieval request.

After identifying the set of parameters of the file retrieval request, the personal device 202-1 compares the parameters to the associations between the event data and the file data. For example, the personal device 202-1 may search for associations having event data matching the parameters of the file retrieval request. Additionally, the personal device 202-1 may identify similarities between parameters of the file retrieval request and the file data of the associations. In some examples, the personal device 202-1 may employ machine learning algorithms to identify similarities between the associations and the parameters of the file retrieval request.

Based on the comparison and the detected similarities, the personal device 202-1 identifies a recommended file. In some examples, more than one recommended file may be identified. Further, the recommended files may be assigned a relevance score based on the comparison and detected similarities. For example, a file which was accessed during a meeting with the same participant accounts as well as a similar file name as specified in the file retrieval request may be assigned a higher relevance score than a file which was accessed during a meeting with the same participant accounts but an entirely unrelated file name.

The recommended file instructions 308, when executed, cause the personal device 202-1 to output the recommended file. For example, the personal device 202-1 may present the recommended file at an event assistant interface at a display of the personal device 202-1. In some examples, such as when the file retrieval request is automatic based on an ongoing event, the personal device 202-1 may not present the recommended file until the user requests to view files, at which point, the personal device 202-1 may highlight the recommended file as recommended. For example, the personal device 202-1 may present a list of files with the recommended file at the top of the list, and the remainder of the list in descending order by files recently accessed by the user. Alternately, the list may be sorted in descending order by the similarity score assigned to the recommended files.

In some examples, the storage medium 300 may additionally store instructions, which, when executed, cause the personal device 202-1 to record new associations between event data and file data. For example, when a user accesses the recommended file or another file owned by the user (e.g., a file stored in the file repository 208) during an ongoing event, the personal device 202-1 may record the file as an accompanying file to the ongoing event. Accordingly, the personal device 202-1 may track and store an association between file data for the accompanying file and event parameters (i.e., the event data) for the ongoing event.

Further, the storage medium 300 may additionally store instructions, which, when executed, cause the personal device 202-1 to, in response to a share request, share the accompanying file with other participant accounts. In particular, the personal device 202-1 may record all accompanying files for an ongoing event. Upon receipt of a share request, the personal device 202-1 may identify the participant accounts for the ongoing event and share the accompanying files with the participant accounts. The accompanying files may be shared, for example, via email, by providing a link with access to an online-accessible file, or other suitable means.

Thus, the personal device 202-1, and in particular the event assistant application, may present a user with a recommended file based on recorded event data and file data associations, as well as continuing to track and build the recorded associations between files accessed during ongoing meetings, and easily share the files accessed during the meetings.

In other examples, the event assistant application may be executed on the shared device 202-2, and hence the event application may not detect an account identifier for which to track ongoing and upcoming events and select recommended file. The shared device 202-2 may therefore cooperate with the server 204 in order to select recommended files. In particular, the event assistant application may allow users to sign into their user accounts temporarily (e.g., for the duration of the meeting) and generate a file retrieval request for the server 204.

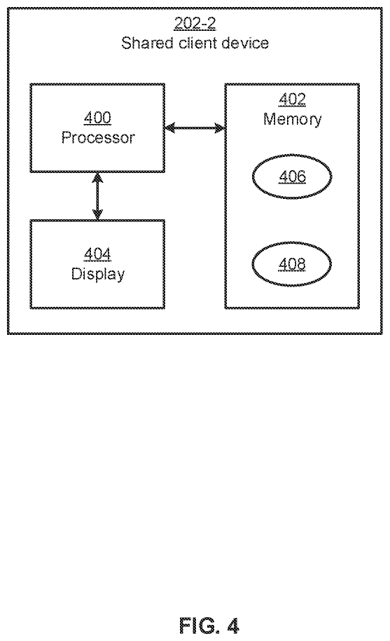

For example, turning to FIG. 4, certain internal components of the shared device 202-2 are depicted. The shared device 202-2 includes a processor 400, a memory 402, and a display 404.

The processor 400 may include a central processing unit (CPU), a microcontroller, a microprocessor, a processing core, or similar device capable of executing instructions. The processor 400 may also include or be interconnected with a non-transitory machine-readable storage medium, such as the memory 402, that may be electronic, magnetic, optical, or other physical storage device that stores executable instructions. In particular, the memory 402 may store an event assistant application 406 for tracking events and obtaining file recommendations, as well as a collaboration application 408 for providing a collaboration interface, such as a whiteboard application, during a collaboration session.

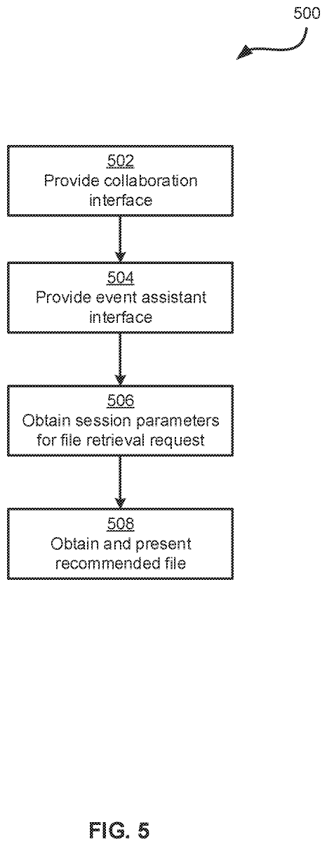

Referring to FIG. 5, a flowchart of an example method 500 of selecting a recommended file at a shared device during a collaboration session is depicted. The method 500 will be described in conjunction with its performance by the shared device 202-2 with reference to the components of FIGS. 2 and 4. In other examples, the method 500 may be performed by other suitable devices or systems.

At block 502, the processor 400, via execution of the collaboration application 408, provides a collaboration interface at the display 404. The collaboration interface allows users to participate in a collaboration session hosted by the collaboration application. For example, the collaboration interface may include an interactive region (e.g., a whiteboard region) in which users may provide input and make notes, drawings, or the like. The collaboration interface may further include customization options, for example to change colors, input types (e.g., freestyle, shapes, tables, etc.), and the like.

At block 504, the processor 400, via execution of the event assistant application 406, provides an event assistant interface at the display 404. The event assistant interface may be overlaid over a portion of the collaboration interface to allow the event assistant interface to be easily accessed during the collaboration session.

In particular, the event assistant interface may be associated with a particular user account. However, as the shared device 202-2 is not regularly associated with an account identifier, the event assistant interface may provide a mechanism to allow the user to log into their user account.

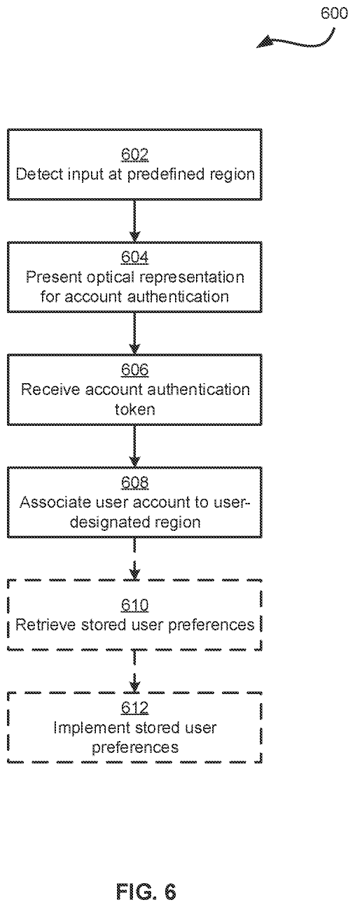

For example, referring to FIG. 6, an example method 600 of associating the event assistant interface with a user account is depicted.

The method 600 is initiated at block 602, where the event assistant interface defines a predefined region of the event assistant interface designated to add an associated user account to the event assistant interface. For example, the event assistant interface may include an account association patch overlaid on the collaboration interface. Additionally, the event assistant interface may define a predefined account association region around the account association patch. When input is detected within the predefined account association region, the shared device 202-2 may determine that a user wishes to associate a user account with the event assistant interface. For example, the input may be when a cursor, pen, or other input device is moved within the account association region. In other examples, an input may only be detected at the account association region when the cursor or pen hovers (i.e., moves into the region and stays in approximately the same position for a threshold period of time) within the account association region.

At block 604, in response to detection of the input within the predefined region of the event assistant interface, the shared device 202-2 generates and presents an optical representation, such as a QR code or a barcode, at the event assistant interface. For example, the account association patch may be replaced by the optical representation. In particular, the optical representation may be scanned by an external device (e.g., a mobile phone of the user) and prompts account authentication of the user at the external device. For example, the optical representation may provide a link to a landing page for logging in to the event assistant interface (e.g., hosted by the server 204). Thus, users may enter their credentials and authenticate their user account at a personal device, rather than entering their credentials at the shared device 202-2, potentially in view of other users.

At block 606, the shared device 202-2 receives an account authentication token for the user account. In some examples, the shared device 202-2 may receive the account authentication token from the external device directly. That is, the optical representation may encode sufficient identification and communication protocol information to allow the external device to send the account authentication token to the external device. In particular, the external device may, upon receipt of the credentials for the user account from the user, validate the credentials with the server 204 and receive an account authentication token representing the account identifier. The external device may then transmit the account authentication token to the shared device 202-2 to allow the shared device 202-2 to access the relevant event data, file data and associations between the event data and the file data for the account identifier. In other examples, after validating the credentials at the server 204, the server 204 may send the account authentication token to the shared device 202-2; that is, the shared device 202-2 may receive the account authentication token from the server 204 rather than from the external device directly.

At block 608, in response to receiving the account authentication token, the shared device 202-2 generates a user-designated region of the event assistant interface and associates the user account with the user-designated region. For example, the user-designated region may include a user account patch overlaid on the collaboration interface. The user account patch provides an interface by which the user may access event data and file data associated with the account identifier. Additionally, the user account patch may provide an interface for performing a file retrieval request and receiving a recommended file based on the ongoing collaboration session (i.e., using the collaboration session parameters as the set of parameters for the file retrieval request).

Notably, the user account patch may be distinct from the account association patch, thus allowing multiple user accounts to be associated with the event assistant interface. Further, each user account associated with the event assistant interface may have a distinct user-designated region (i.e., user account patch). Further, in some examples, the account association patch and the user account patches may be movable based on input from the user. For example, any user may hold and drag the account association patch to a different location on the display 404. Similarly, a user input device associated with the user account for a particular user account patch (as described below) may hold and drag their corresponding user account patch to a different location on the display 404. The event assistant interface may therefore be interactive and dynamic according to input from users.

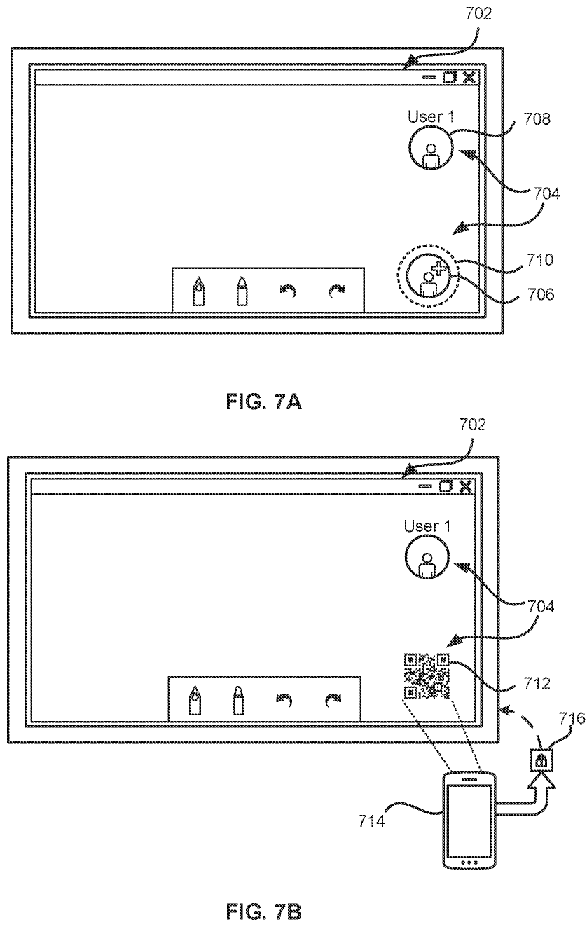

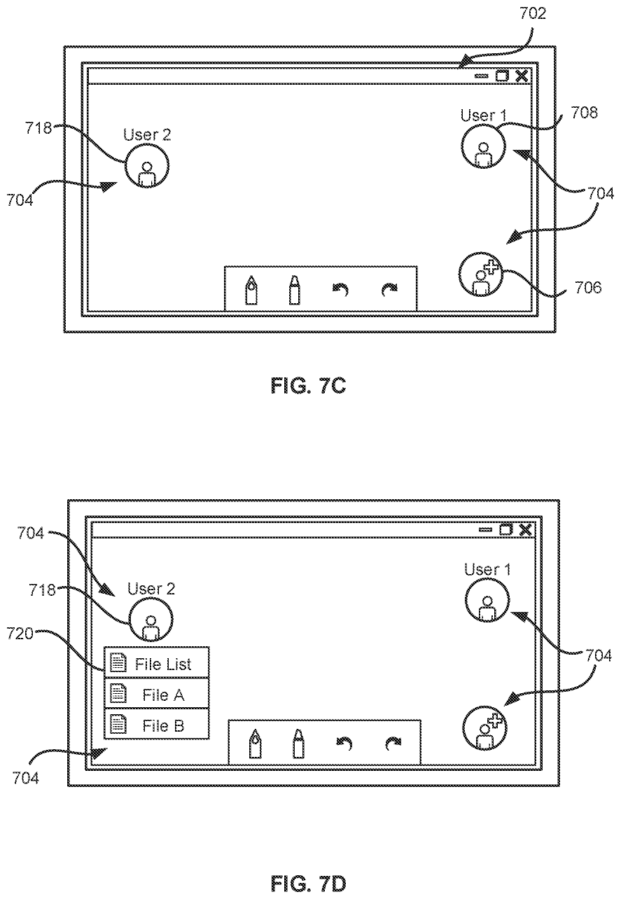

For example, referring to FIG. 7A-7C, schematic diagrams of the shared client device 202-2 during execution of the method 600 are depicted. FIG. 7A depicts the shared device 202-2 displaying a collaboration interface 702 and an event assistant interface 704. The event assistant interface 704 includes an account association patch 706, as well as a user-designated region, depicted as a user account patch 708. The user account patch 708 is associated with a first user account.

When the shared device 202-2 detects user input within a predefined account association region 710, the shared device 202-2 provides an optical representation 712 to be scanned by an external device 714 (FIG. 7B). In the present example, the predefined account association region 710 is a predefined region about the account association patch 706. The account association patch 706 may be replaced with the optical representation 712 to restrict account associations to the event assistant interface to one at a time. In the present example, the optical representation 712 is a QR code.

The external device 714 may scan the optical representation 712 to generate a landing page at which a user of the external device 714 may enter their credentials for a second user account (different from the first user account associated with the user account patch 708). After entering their credentials, and validating their credentials at a server (not shown), the external device 714 sends an account authentication token 716 to the shared device 202-2.

Referring to FIG. 7C, upon receiving the account authentication token 716, the shared device 202-2 generates another user-designated region, depicted as a user account patch 718, which is associated with the second user account. As can be seen, each user-designated region has a distinct user account patch 708, 718 to distinguish them from one another and to allow each user account to access their respective event data and file data and make respective file retrieval requests. Further, the event assistant interface, having completed the account association of the second user account to the user account patch 718, may again provide the account association patch 706 and the predefined region 710 about the account association patch 706 to allow additional user accounts to be associated with the event assistant interface.

Returning to FIG. 6, at block 610, in some examples, upon receiving the account authentication token and associating the user-designated region, the shared device 202-2 may additionally retrieve stored user preferences for the user account. In particular, in order to apply the user preferences, the shared device 202-2 may detect an identifier of an input device and associate the input device identifier with a particular account identifier. When the input detected in the predefined region is received from an unassigned input device, after receiving the account authentication token, the shared device 202-2 may associate the user account with the input device and retrieve stored user preferences for the user account. The user preferences may relate, for example, to physical input settings for an input device (e.g., pen tilt and pressure, sensitivity, and the like) as well as style settings for displaying the input on the shared device 202-2 (e.g., stroke thickness, colors, and the like).

At block 612, the shared device 202-2 detects further input from the input device and implements the stored user preferences. For example, when detecting that the input device is drawing a line, the shared device 202-2 may render the line in accordance with the detected tilt and pressure and the user preferences obtained at block 610, as well as stylize the line in accordance with the user preferences obtained at block 610.

Returning to FIG. 5, after associating a user account with the event assistant interface, at block 506, the processor 400 may obtain session parameters for the collaboration session and use the session parameters as parameters for a file retrieval request. In particular, the shared device 202-2 may send a file retrieval request to the server 204 based on the user account associated with the meeting assistant interface to avoid downloading user account-specific event data and file data at the shared device 202-2 and to conserve processing power of the shared device 202-2. In other examples, the file retrieval request may be processed at the shared device 202-2, for example via performance of the method 100.

At block 508, the shared device 202-2 obtains the recommended file either from the server 204 or via execution of the method 100 at the shared device 202-2 and presents the recommended file at the event assistant interface. For example, the shared device 202-2 may display file data, such as a file name, for the recommended file at or near the user-designated region for the user account. The recommended file may be presented in response to user input to view files owned by the user account, for example by selecting an option to view files in the user-designated region of the event assistant interface.

For example, referring to FIG. 7D, the event assistant interface 704, and in particular, the second user-designated region, may include a file list 720 in close proximity to the user account patch 718. The file list 720 may display the file name of the recommended file. In some examples, where more than one recommended file is generated or when the recommended files are assigned scores, the file list 720 display the recommended files in descending order according to their relevance (e.g., by their score). In other examples, the file list 720 may simply display the recommended file at the top, and the rest of the files in descending order by most recently accessed date.

In some examples, the shared device 202-2, via execution of the event assistant application 406, may additionally record new associations between event data and file data. For example, when a user accesses the recommended file or another file owned by the user during an ongoing collaboration session, the shared device 202-2 may record the file as an accompanying file to the collaboration session. Accordingly, the shared device 202-2 may track an association between the file data for the accompanying file and session parameters (i.e., the event data) for the collaboration session. Since the shared device 202-2 is not associated with a particular account, the shared device 202-2 may additionally track the user account accessing the file and send the recorded association for the user account to the server 204 for storage.

Further, the shared device 202-2, via execution of the event assistant application 406, may allow users to share accompanying files with other participant accounts in a collaboration session. For example, the event assistant interface, and in particular the user-designated region associated with a user account, may have an option for the user to submit a share request. In particular, the shared device 202-2 may record accompanying files for an ongoing collaboration session. In response to a share request, the shared device may identify the participant accounts for the collaboration session and share the accompanying files with the participant accounts. The accompanying files may be shared via email, by providing a link with access to an online-accessible file, or other suitable means.

The shared device 202-2, via execution of the event assistant application 406, may also allow users to record the contents of a collaboration session. For example, the event assistant interface, and in particular the user-designated region associated with a user account, may have an option for the user to submit a record request. In response to the record request, the shared device 202-2 may store content registered at the collaboration interface. The content may be stored and sent, for example to the server 204 in association with the user account to allow the user to log into their user account and access the stored content from a personal device.

The content of the collaboration interface may be stored as an image, as raw data (e.g., vector data) based on data received from the collaboration application, or the like. In some examples, the content of the collaboration interface may be transcribed to a designated file format according to a predefined template. For example, the designated file format may be a text file, a structured list (e.g., a to-do file or task tracker), or the like. The predefined template may use optical character recognition of the content of the collaboration interface and predefined rules to define how to format certain features. For example, dots in-line with and preceding a line of text may be determined to be bullet points and structured as such in the designated file format. Other rules for defining templates are also contemplated.

As described above, example methods, applications and devices provide file recommendations based on recorded event data and file data associations. Event data and file data may be stored at repositories, and associations between the event data and the file data is tracked. The associations represent accesses of an accompanying file during an ongoing event. Based on the recorded contextual data, a set of parameters for a file retrieval request may be compared to the associations to select a recommended file. Thus the recommended file may be one with associations to events similar to the file retrieval request. The file retrieval request may be, for example, based on an ongoing event, or may be manual based on user input. The selection may be performed by a machine learning engine.

The event assistant application may be implemented on a personal computing device associated with a particular user account, or a shared computing device executing a whiteboard or other collaboration application. The application may further include functions to record the content of a collaboration application and to share files accessed during the ongoing event. The application may further allow multiple accounts to be signed in when implemented on a shared device, as well as providing authentication privacy by providing an optical representation for account authentication. Each account may have its own patch overlaid on the collaboration interface to provide the file recommendation, sharing, and recording functions. Each account may also be associated with designated input devices to implement different stored user preferences.

The scope of the claims should not be limited by the above examples, but should be given the broadest interpretation consistent with the description as a whole.

1. A method comprising:
storing, for an account identifier representing a user account, event data for events associated with the account identifier and file data for files owned by the account identifier;
tracking associations between the event data and the file data, each association representing a recorded access of a file during an event;
obtaining a set of parameters for a file retrieval request;
comparing the set of parameters and the associations between the event data and the file data; and
selecting a recommended file for the file retrieval request based on the comparison of the set of parameters and the associations between the event data and the file data.

2. The method of claim 1, further comprising performing the obtaining, comparing, and selecting in response to initiating a subsequent event as the file retrieval request, and wherein the set of parameters comprises event parameters for the subsequent event.

3. The method of claim 1, further comprising performing the obtaining, comparing, and selecting in response to receiving the file retrieval request as user input, wherein the user input includes the set of parameters.

4. The method of claim 1, further comprising, during an ongoing event:
retrieving event parameters for the ongoing event;
recording an accompanying file accessed by the user account during the ongoing event; and
storing an association between the file data for the accompanying file and the event parameters for the ongoing event.

5. A computing device comprising:
a display;
a memory storing a collaboration application and an event assistant application;
a processor interconnected with the display and the memory, the processor to:
provide collaboration interface at the display, the collaboration interface allowing a user account to participate in a collaboration session hosted by the collaboration application;
provide an event assistant interface at the display, the event assistant interface associated with the user account;
obtain session parameters for the collaboration session;
obtain a recommended file based on a comparison of the session parameters and associations between event data for events associated with the user account and file data for files owned by the user account; and
present the recommended file at the event assistant interface.

6. The computing device of claim 5, wherein the processor is to overlay the event assistant interface over a portion of the collaboration interface.

7. The computing device of claim 5, wherein the processor is to: in response to a record request, store content registered at the collaboration interface in a memory of the computing device.

8. The computing device of claim 7, wherein the processor is further to transcribe the content to a designated file format according to a predefined template.

9. The computing device of claim 5, wherein the processor is to:
record an accompanying file accessed by the user account during the collaboration session; and
store an association between the file data for the accompanying file and the session parameters for the collaboration session.

10. The computing device of claim 9, wherein the processor is to: in response to a share request, share the accompanying file accessed by the user account with participant accounts associated with the collaboration session.

11. The computing device of claim 5, wherein to associate the event assistant interface with the user account, the processor is to:
detect an input within a predefined region of the event assistant interface;
provide an optical representation to be scanned by an external device, wherein scanning the optical representation prompts account authentication of the user account at the external device; and
receive, from the external device, the account authentication for the user account; and
associate the user account with a user-designated region of the event assistant interface.

12. The computing device of claim 11, wherein the processor is to:
when the input detected is received from an unassigned input device, after receiving the account authentication, associate the user account with the input device;
retrieve stored user preferences for the user account; and
implement the stored user preferences when detecting further input from the input device.

13. The computing device of claim 11, wherein the processor is further to:
detect an additional input within the predefined region of the event assistant interface;
provide an additional optical representation to be scanned by an additional external device, wherein scanning the additional optical representation prompts an additional account authentication of an additional user account at the additional external device; and
receive, from the additional external device, the additional account authentication for the additional user account; and
associate the additional user account with an additional user-designated region of the event assistant interface.

14. A non-transitory machine-readable storage medium storing machine-readable instructions executable by a processor, which, when executed, cause the processor to:
retrieve event data representing events associated with a user account;
retrieve file data representing files owned by the user account;
obtain, for the user account, associations between the event data and the file data, wherein each association represents an access of a file during an event;
in response to a file retrieval request, compare a set of parameters of the file retrieval request to the associations between the event data and the file data; and
provide a recommended file in response to the file retrieval request.

15. The non-transitory machine-readable storage medium of claim 14, wherein execution of the instructions further causes the processor to:
record an accompanying file accessed by the user account during an ongoing event; and
store an association between the file data for the accompanying file and event parameters of the ongoing event.
